(19) United States
(12) Patent Application Publication
(10) Pub. No.: US 2008/0233234 A1
(43) Pub. Date: Sep. 25, 2008

(54) CHEWING GUM AND GUM BASES CONTAINING POLYOLEFIN THERMOPLASTIC ELASTOMERS

(75) Inventors: Chungsea Shen, Deerfield, IL (US); Bruno Padovani, Naperville, IL (US); Joo H. Song, Chicago, IL (US)

Correspondence Address: Derick E. Allen (28850);ARMSTRONG TEASDALE LLP, ONE METROPOLITAN SQUARE, SUITE 2600, ST. LOUIS, MO, 63102-2740, US

(73) Assignee: WM. WRIGLEY JR. COMPANY, Chicago, IL (US)

(21) Appl. No.: 12/046,189

(22) Filed: Mar. 11, 2008

Related U.S. Application Data
(60) Provisional application No. 60/894,396, filed on Mar. 12, 2007.

(51) Int. Cl. A23G 4/08

(52) U.S. Cl. 426/6

(57) ABSTRACT

Described herein are improved chewing gum base and chewing gum formulations including polyolefin thermoplastic elastomers. Also described herein are methods for preparing the chewing gum bases and chewing gums of the present invention. For example, in accordance with the present invention polyolefin thermoplastic elastomers may be included in sucrose-containing gum formulations or sugar-free chewing gums.

### CROSS-REFERENCE TO RELATED APPLICATIONS

This application claims benefit to U.S. Provisional Application No. 60/894,396, filled Mar. 12, 2007, incorporated by reference herein.

### BACKGROUND OF THE INVENTION

The present invention relates generally to chewing gum. More specifically, the present invention relates to improved formulations for chewing gum and gum bases.

Chewing gum generally consists of a water insoluble gum base and a water soluble portion along with flavors. The water soluble portion and flavors dissipate during chewing and the gum base is retained in the mouth throughout the chew.

The insoluble gum base generally comprises elastomers, resins, fats and oils, softeners, and inorganic fillers. Elastomers can include synthetic elastomers including polyisobutylene, isobutylene-isoprene copolymers, styrene-butadiene copolymers, polyvinyl acetate, polyisoprene, polyethylene, vinyl acetate-vinyl laurate copolymers, and combinations thereof. Natural elastomers that can be used include natural rubber.

The gum base may include elastomer plasticizers including, for example, natural rosin esters.

Additionally, the gum base may include fillers/texturizers and softeners/emulsifiers. Softeners are added to chewing gum in order to optimize the chewability and mouth feel of the gum. Softeners/emulsifiers that are typically used include tallow, hydrogenated tallow, hydrogenated and partially hydrogenated vegetable oils, cocoa butter, glycerol monostearate, glycerol triacetate, lecithin, and combinations thereof.

In addition to a water insoluble gum base portion, a typical chewing gum composition includes a water soluble portion and one or more flavoring agents. The water soluble portion generally includes bulk sweeteners, high intensity sweeteners, flavoring agents, softeners, emulsifiers, colors, acidulants, fillers, antioxidants, and other components that provide desirable attributes.

### SUMMARY OF THE INVENTION

The present invention provides improved chewing gum formulations and chewing gum bases, as well as methods of producing chewing gum and chewing gum bases. In accordance with the present invention, chewing gum is provided that includes polyolefin thermoplastic elastomers (herein referred to as polyolefin TPE's). Polyolefin TPE's can be used in gum base and/or gum formulations as an elastomer. In various preferred embodiments, polyolefin TPE's are added to gum formulations as a replacement of a small or large quantity of other elastomers.

A variety of gum base and chewing gum formulations including polyolefin TPE's can be created and/or used in accordance with the present invention. The base formulations of the present invention may be conventional bases that include wax or are wax-free, tacky or non-tacky and/or bubble gum-type bases. The gum formulations can be low or high moisture formulations containing low or high amounts of moisture-containing syrup. Polyolefin TPE's can be used in sugar-containing chewing gums and also in low sugar and non-sugar containing gum formulations made with sorbitol, mannitol, other polyols, and non-sugar carbohydrates. Non-sugar formulations can include low or high moisture sugar-free chewing gums.

In various preferred embodiments, polyolefin TPE is used as an elastomer and is combined with other base elastomers for use in chewing gum base. Such other elastomers include synthetic elastomers including polyisobutylene, isobutylene-isoprene copolymers, styrene-butadiene copolymers, polyvinyl acetate, polyisoprene, polyethylene, vinyl acetate-vinyl laurate copolymers, and combinations thereof. Natural elastomers that can be used include natural rubbers such as chicle. In general, when a blend of elastomers is to be used, it is preferred to combine the polyolefin TPE's of the present invention with polyisobutylene elastomer or with butyl rubber. A preferred gum base blend contains about 1 to 5 wt. % polyisobutylene elastomer.

In various other preferred embodiments, polyolefin TPE is used as an elastomer in chewing gum formulations to replace typical chewing gum elastomers.

The polyolefin TPE, when used according to the present invention, affords the chewing gum an improved texture, improved shelf life, and improved flavor quality. Even though polyolefin TPE's are similar to other elastomers in some respects, polyolefin TPE's create a resultant chewing gum product that has a high consumer-acceptability.

The present invention provides in some embodiments an improved chewing gum formulation, improved shelf life, and improved flavor quality.

Additional features and advantages of the present invention are described in, and will be apparent from, the detailed description of the presently preferred embodiments.

### DESCRIPTION OF THE INVENTION

The present invention provides improved chewing gum formulation and gum base formulations. In accordance with the present invention, polyolefins can be used in chewing gum formulations and gum bases. Specifically, polyolefin TPE's can be used as elastomers in chewing gum bases.

Polyolefin TPE's are a family of elastomeric polymers within a larger group of olefin polymers and which, in their final state, are capable of being repeatedly softened by an increase of temperature and hardened by a decrease of temperature. Olefins are unsaturated hydrocarbons and most typical monomers used in polyolefins are ethylene and alpha-olefins containing up to ten carbon atoms. Principal olefin monomers include ethylene, propylene, butene-1,4-methylpentene, hexene, octene and combinations thereof. Polyolefins include ethylene polymers, propylene polymers, and combinations thereof including combinations with other C₄-C₁₀ alpha-olefins. Suitable polyolefin TPE's useful in this invention are available from Dow Chemical Co. of Midland, Mich. under the tradename ENGAGE™. Another particularly preferred polyolefin TPE are sold under the trade name Vistamaxx™ by Exxon Mobil Chemical of Houston, Tex. Elastomeric polyolefins typically contain ethylene and propylene, and may contain other C₄-C₁₀ olefin monomer units. Some particularly preferred polyolefin TPE's are copolymers of ethylene with at least one other olefin monomer, such as ethylene-propylene copolymers and ethylene-octene copolymers.

Polyolefin TPE's may be used to develop new types of chewing gum products and generally exhibit one or more unique attributes including, for example, high elasticity, softness, toughness, flexibility, and/or cohesion. Polyolefin TPE's may be prepared using metallocene-based catalyst systems to create polymers with increased elasticity, greater strength, greater cohesion, flexibility and/or toughness. Polyolefin TPE's may be tailored for specific attributes in different applications in multiple ways and as specialty elastomers can be used as replacements or partial replacement of synthetic rubber elastomers in chewing gum base. Polyolefin TPE's may also be blended in various combinations to replace or partially replace natural elastomers such as chicle, Sorva, and Jelutong, or may replace or partially replace synthetic rubber elastomers in chewing gum base. Typical synthetic rubber elastomers normally used in chewing gum bases are styrene butadiene rubber (SBR), isobutylene-isoprene copolymers (butyl rubber), and polyisobutylene (PIB).

Polyolefin TPE's are available in a variety of grades for various types of applications. Various grades are used in plastic films with polypropylene (PP) or other types of thermoplastic olefin (TPO) films to modify the films. These types of films are FDA approved for use in contact with food, but are not food approved by the FDA for use in chewing gum. The various types of polyolefin materials developed for contact with food may be combined with other types of polyolefins or other types of natural or synthetic rubber elastomers to make chewing gum bases.

Polyolefin TPE's can be used in a variety of different chewing gum and gum base formulations. Typically, one or more polyolefin TPE's constitutes from about 1% to about 40% by weight of the chewing gum base, more typically from about 5% to about 30% by weight of the chewing gum base (e.g., preferably from about 5% to about 20% by weight of the gum base). As a result, polyolefin TPE's typically constitute from about 0.1% to about 15% by weight of chewing gum formulations, or from about 0.2% to about 10% by weight of chewing gum formulations. Polyolefin TPE's may be blended with other suitable natural or synthetic elastomers as a component in a gum base.

Polyolefin TPE's can be used in a variety of different chewing gum base formulations. Gum bases may contain natural or synthetic elastomers, may contain wax or may be wax-free. Polyolefin TPE's may be used in conventional gum base formulations, in bubble gum formulations, or non-tack gum base formulations. Gum formulations of the present invention may be used for stick gums, tab gums, coated pellet gums, center filled gums, or may be sugar or sugar-free chewing gums

The insoluble gum base generally comprises elastomers, resins, fats and oils, softeners, and inorganic fillers. The gum base may or may not include wax. The insoluble gum base may constitute from about 5 to about 95% by weight of the chewing gum, typically constitute from about 10 to about 50% by weight of the chewing gum and, in various preferred embodiments, constitute from about 20 to about 35% by weight of the chewing gum.

In various embodiments, the chewing gum base of the present invention contains from about 7 to about 60% by weight synthetic elastomer, from about 0 to about 30% by weight natural elastomer, from about 5 to about 55% by weight elastomer plasticizer, from about 4 to about 35% by weight filler, from about 5 to about 35% by weight softener, and optional minor amounts (e.g., about 1% by weight or less) of miscellaneous ingredients such as colorants, antioxidants, and the like.

Synthetic elastomers may include, but are not limited to, polyisobutylene with a GPC weight average molecular weight of about 10,000 to about 95,000, isobutylene-isoprene copolymer (butyl elastomer), styrene-butadiene copolymers having styrene-butadiene ratios of about 1:3 to about 3:1, polyvinyl acetate having a GPC weight average molecular weight (MW) of about 2,000 to about 90,000, polyisoprene, polyethylene, vinyl acetate-vinyl laurate copolymer having vinyl laurate content of about 5 to about 50 percent by weight of the copolymer, and combinations thereof.

Thermoplastic elastomers typically are low modulus, flexible polymeric materials, which can be stretched to at least twice their original length at ambient temperature with an ability to return to substantially their original length after the stretching stress has been released. Further, such elastomers are thermoplastic in the sense that they are processable as a melt at elevated temperatures. A polyolefin thermoplastic elastomer is a thermoplastic elastomer in which the polymeric material is an olefin polymer, typically containing C₂ to C₈ olefin units (preferably C₂ to C₄) and more preferably an olefin polymer containing C₂ and C₃ olefin units. A most preferable polyolefin thermoplastic elastomer is a copolymer of propylene and ethylene.

A polyolefin TPE suitable for use in a chewing gum base should be sufficiently pliable at typical mouth temperatures (e.g., 35-40° C.) to give good mouthfeel. Typically, such polyolefin TPE is capable of being softened through incorporation of plasticiser or softener materials to provide a gum base composition having consumer-acceptable mouthfeel.

A suitable polyolefin TPE used in this invention typically should be essentially without taste and an ability to incorporate flavor materials which provide a consumer-acceptable flavor sensation. Further, preferably, such polyolefin TPE is nontoxic and food acceptable and therefore capable of being food approved by government regulatory agencies.

Typically, a polyolefin TPE has sufficient cohesion such that a chewing gum composition containing such material retains cohesion during the chewing process and forms a discrete gum cud. An embodiment of a polyolefin TPE useful in this invention includes a polyolefin TPE having partial polymeric crystallinity to maintain acceptable cohesion during a chewing process. Polymeric crystallinity may be confirmed through x-ray diffraction spectrometry or observation of a polymeric crystalline melting point phase change in a differential scanning calorimeter (DSC) thermogram.

Typical properties of suitable polyolefin TPE's useful in this invention include having a specific gravity between 0.855 and 0.90, preferably 0.860 to 0.870; melt flow rate (MFR, D1238, 2.16 kg, 230° C.) of 1 to 30 g/10 min, preferably 2 to 25 g/10 min.; a glass transition temperature (T_{g}) of −10 to −60° C., preferably −20 to −50° C.; a crystalline melting point (Tₘ by DSC) of 40 to 160° C., preferably 50 to 150° C.; an ultimate elongation of 100 to 1500%, preferably 200 to 1000%; an elastic recovery of 75 to 98%, preferably 80 to 97%; a tensile strength of 2 to 35 MPa, preferably 5 to 30 MPa; a Mooney viscosity of 4 to 35, preferably 5 to 30; and a Shore hardness A of 40 to 100, preferably 50 to 90. A characteristic of a polyolefin TPE made using a metallocene catalyst system is a relative narrow polydispersity (molecular weight distribution measured as M_{w}/Mₙ) typically between 1.5 and 2.5, preferably 1.8 to 2.2, and usually around 2.

Typical polyolefin TPE's useful in this invention are polymers of ethylene with co-monomers of propylene, butene, hexene, and octene. Copolymers of ethylene with propylene or octene are preferred. Co-monomer content typically is above about 10 wt. % and may range up to 90 wt. %. Preferred co-mononer contents are between 10 and 20 wt. % for propylene/ethylene and typically 35 to 55 wt. % for ethylene/octene. The amount of co-monomer used usually depends on the properties desired.

In one embodiment a polyolefin TPE, typically comprising a propylene/ethylene copolymer (such as sold under the Vistamaxx™ tradename), useful in this invention has the following physical characteristics:

| | |
|---|---|
| Specific Gravity | 0.86-0.89 |
| Melt Flow Rate (ASTM D1238, 230° C.) | 1-25 g/10 min. |
| Mooney Viscosity ML | 5-30 |
| Molecular Weight | 150,000-250,000 |
| Polydispersity (M_{w}/Mₙ) | 1.8-2.2 (preferably ca. 2) |
| T_{g} | −10-−30° C. |
| Tₘ | 40-160° C. |
| Shore Hardness A | 50-90 |
| Tensile Strength | 15-28 MPa |
| Elongation | 100-1000% |
| Elastic Recovery | 80-97% |

Particularly advantageous ethylene/propylene copolymers have densities of 0.862 and 0.861 g/cm³, MFR's of 22 and 18 g/10 min., and co-monomer contents of 14 and 15 wt. %., each with high elasticity, (such as sold under the Vistamaxx™ 1120 and 6202 tradenames).

In another embodiment a polyolefin TPE, typically comprising a propylene/octene copolymer with an octene content of around 42 wt. % (such as sold under the Engage 8130™ tradename, useful in this invention has the following approximate physical characteristics:

| Density | 0.864 g/cm³ |
|---|---|
| Melt Flow Rate (ASTM D1238, 190° C.) | 13 g/10 min. |
| Mooney Viscosity ML @121° C. (ASTM D1646) | 4 |
| T_{g} | −55° C. |
| Tₘ | 56° C. |
| Shore Hardness A (ASTM D2240) | 63 |
| Shore Hardness D (ASTM D2240) | 13 |
| Flexural Modulus (ASTM D790) | |
| 1% Secant | 7.8 MPa |
| 2% Secant | 7.3 MPa |
| Tear Strength (ASTM D624) | 26.4 kN/m |
| Tensile Strength | 2.4 MPa |
| Ultimate Elongation (ASTM D638, 508 mm/min) | 800% |

An example of a propylene-based stereoblock thermoplastic elastomer is described in U.S. Pat. No. 5,969,070, incorporated herein by reference.

Preferred characteristics of suitable synthetic elastomers include, for polyisobutylene, a Gel Permeation Chromatography (GPC) weight average molecular weight of from about 50,000 to about 80,000, for styrene-butadiene, 1:1 to 1:3 bound styrene:butadiene ratio, for polyvinyl acetate, a relatively low GPC weight average molecular weight of from 10,000 to 65,000 with the higher molecular weight polyvinyl acetates typically used in bubble gum base, and for vinyl acetate-vinyl laurate, a vinyl laurate content of 10-45 percent.

Natural elastomers may include natural rubber such as smoked or liquid latex and guayule as well as natural gums such as jelutong, lechi caspi, perillo, sorva, massaranduba balata, massaranduba chocolate, nispero, rosindinha, chicle, gutta hang kang, and combinations thereof. The preferred synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Elastomer plasticizers or softeners may include, but are not limited to, natural rosin esters (often referred to as estergums), such as glycerol esters of partially hydrogenated rosin, glycerol esters polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing. The preferred elastomer plasticizers will also vary depending on the specific application and on the type of elastomer is used.

Fillers/texturizers may include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof.

In various embodiments of the present invention, softeners/emulsifiers may include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids), and combinations thereof.

Colorants and whiteners may include FD&C-type dyes and lakes, fruit and vegetable extracts, titanium dioxide, and combinations thereof.

As noted, the base may include wax or be wax-free. An example of a wax-free gum base is disclosed in U.S. Pat. No. 5,286,500, the disclosure of which is incorporated herein by reference.

In addition to a water insoluble gum base portion, a typical chewing gum composition includes a water soluble bulk portion and one or more flavoring agents. The water soluble portion can include bulk sweeteners, high intensity sweeteners, flavoring agents, softeners, emulsifiers, colors, acidulants, fillers, antioxidants, and other components that provide desired attributes.

The softeners, which are also known as plasticizers and plasticizing agents, generally constitute from about 0.5 to about 15% by weight of the chewing gum. The softeners may include glycerin, lecithin, and combinations thereof. Aqueous sweetener solutions such as those containing sorbitol, hydrogenated starch hydrolysates, corn syrup, and combinations thereof, may also be used as softeners and binding agents in chewing gum.

Bulk sweeteners typically include both sugar and sugarless components. Bulk sweeteners typically constitute from about 5 to about 95% by weight of the chewing gum, more typically from about 20 to about 80% by weight and, still more typically, from about 30 to about 60% by weight of the gum.

Sugar sweeteners generally include saccharide containing components commonly known in the chewing gum art, including, but not limited to, sucrose, dextrose, maltose, dextrin, dried invert sugar, fructose, levulose, galactose, corn syrup solids, and the like, alone or in combination.

In various embodiments, sorbitol may be used as a sugarless sweetener. Additionally, sugarless sweeteners can include, but are not limited to, other sugar alcohols such as mannitol, xylitol, hydrogenated starch hydrolysates, maltitol, lactitol, erythritol and the like, alone or in combination.

High intensity artificial sweeteners can also be used in combination with the above-described sweeteners. Preferred sweeteners include, but are not limited to sucralose, aspartame, salts of acesulfame, alitame, neotame, saccharin and its salts, cyclamic acid and its salts, glycyrrhizin, stevia, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extrusion may be used to achieve the desired release characteristics.

Usage level of the artificial sweetener will vary greatly and will depend on such factors as potency of the sweetener, rate of release, desired sweetness of the product, level and type of flavor used and cost considerations. Thus, the active level of artificial sweetener may vary from 0.02 to about 8% by weight. When carriers used for encapsulation are included, the usage level of the encapsulated sweetener will be proportionately higher.

Combinations of sugar and/or sugarless sweeteners may be used in chewing gum. Additionally, the softener may also provide additional sweetness such as with aqueous sugar or alditol solutions.

If a low calorie gum is desired, a low caloric bulking agent can be used. Example of low caloric bulking agents include: polydextrose; Raftilose, Raftilin; Fructooligosaccharides (NutraFlora®); Palatinose oligosaccharide; Guar Gum Hydrolysate (Sun Fiber); or indigestible dextrin (Fibersol). However, other low calorie bulking agents can be used.

A variety of flavoring agents may be incorporated in chewing gum formulations of the present invention. The flavor may be used in amounts of from about 0.1 to about 15% by weight of the gum, and preferably from about 0.2 to about 5% by weight of the gum. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like, and combinations thereof. Artificial flavoring agents and components may also be used. Natural and artificial flavoring agents may be combined in any sensorially acceptable fashion.

The present invention, it is believed, can be used with a variety of processes for manufacturing chewing gum.

Chewing gum base may be made by conventional batch mixing processes or continuous mixing processes. Process temperatures are generally from about 120° C. to about 160° C. for processing times of from about 1.5 to about 2 hours. Generally, rubber compounding is done first in a combination of smearing, stretching, folding, dividing, and recombining along with any needed filler. Polyolefin TPE's may be compound together with any rubber used in a formulation. Next, elastomer plasticizers such as terpene resins or ester gums are added followed by plastic resins such as polyvinyl acetate. This is followed by the addition of softeners and emulsifiers such as waxes, fats, oils, and any other emulsifiers. The completed base is then cooled and processed into pellets or slabs.

Chewing gum is generally manufactured by sequentially adding the various chewing gum ingredients to commercially available mixers known in the art. After the ingredients have been thoroughly mixed, the chewing gum mass is discharged from the mixer and shaped into the desired form, such as by rolling into sheets and cutting into sticks, extruding into chunks, or casting into pellets.

Generally, the ingredients are mixed by first melting the gum base and adding it to the running mixer. The gum base may alternatively be melted in the mixer. Color and emulsifiers can be added at this time.

A chewing gum softener such as glycerin can be added next along with part of the bulk portion. Further parts of the bulk portion may then be added to the mixer. Flavoring agents are typically added with the final part of the bulk portion. The entire mixing process typically takes from about five to about fifteen minutes, although longer mixing times are sometimes required.

By way of further example, gum bases may typically be prepared by batch process using essentially any standard, commercially available mixer known in the art (e.g., a Sigma blade mixer), which involves sequentially adding an amount of the elastomer component and other components to a heated mixer. The initial amount of ingredients is determined by the working capacity of the mixing kettle in order to attain a proper consistency. After the initial ingredients have massed homogeneously, the balance of the components are typically added in a sequential manner until a completely homogeneous molten mass is attained. This can usually be achieved in one to three hours, depending on the formulation. The final mass temperature may typically be between about 70° C. and about 130° C., with a temperature between about 100° C. and about 120° C. being more typical. The completed molten mass is emptied from the mixing kettle into coated or lined pans, extruded or cast into any desirable shape and allowed to cool and solidify.

Alternatively, however, continuous processes using mixing extruders, which are generally known in the art, may optionally be used to prepare the gum base. In a typical continuous mixing process, ingredients are added continuously at various points along the length of the extruder, before discharging the mass as a homogeneous gum base. Typically, the transit time through the extruder will be substantially less than an hour. After the initial ingredients have massed homogeneously and have been sufficiently compounded, the balance of the base ingredients are added at various points along the length of the extruder until a completely homogeneous molten mass is attained. Typically, any remainder of elastomer component or other components are added after the initial compounding stage. The optional components are typically added after the elastomer component. The composition is then further processed to produce a homogeneous mass before discharging from the extruder.

Exemplary methods of extrusion, which may optionally be used in accordance with the present invention, include the following, the entire contents of each being incorporated herein by reference: (i) U.S. Pat. No. 6,238,710, claims a method for continuous chewing gum base manufacturing, which entails compounding all ingredients in a single extruder; (ii) U.S. Pat. No. 6,086,925 discloses the manufacture of chewing gum base by adding a hard elastomer, a filler and a lubricating agent to a continuous mixer; (iii) U.S. Pat. No. 5,419,919 discloses continuous gum base manufacture using a paddle mixer by selectively feeding different ingredients at different locations on the mixer; and, (iv) yet another U.S. Pat. No. 5,397,580 discloses continuous gum base manufacture wherein two continuous mixers are arranged in series and the blend from the first continuous mixer is continuously added to the second extruder.

In yet another alternative, it is possible to prepare the gum base and chewing gum in a single high-efficiency extruder as disclosed in U.S. Pat. No. 5,543,160. Chewing gums of the present invention may be prepared by a continuous process comprising the steps of: a) adding gum base ingredients into a high efficiency continuous mixer; b) mixing the ingredients to produce a homogeneous gum base, c) adding at least one sweetener and at least one flavor into the continuous mixer, and mixing the sweetener and flavor with the remaining ingredients to form a chewing gum product; and d) discharging the mixed chewing gum mass from the single high efficiency continuous mixer.

By way of example, and not limitation, examples of the present invention will now be given:

### ILLUSTRATIVE EXAMPLES

The following contemplative illustrative examples of the invention and comparative examples are provided by way of explanation and illustration. The following examples provide illustrative chewing gum formulations and gum base formulations (Illustrative Examples 75-140) that may be included in these chewing gum formulations. The amounts listed are in weight percent.

The formulations listed in Table 1 comprise various contemplative sugar illustrative formulations in which polyolefins can be used in base and gum formulations.

TABLE 1

| | Illustrative Examples | | | | | |
|---|---|---|---|---|---|---|
| | 1 | 2 | 3 | 4 | 5 | 6 |
| Sugar | 61.6 | 61.6 | 61.6 | 63.0 | 63.0 | 63.0 |
| Gum Base | 19.2 | 19.2 | 19.2 | 19.2 | 19.2 | 19.2 |
| Corn Syrup | 16.9 | 16.9 | 16.9 | 16.9 | 16.9 | 16.9 |
| Peppermint | 0.9 | 0.9 | 0.9 | 0.9 | 0.9 | 0.9 |
| Flavor | | | | | | |
| Glycerin | 1.4 | 1.4 | 1.4 | 0.0 | 0.0 | 0.0 |

Table 2 illustrates addition of dextrose monohydrate to a sugar formulation.

TABLE 2

| | Illustrative Examples | | | | | |
|---|---|---|---|---|---|---|
| | 7 | 8 | 9 | 10 | 11 | 12 |
| Sugar | 55.7 | 55.7 | 55.7 | 56.7 | 56.7 | 56.7 |
| Base | 19.2 | 19.2 | 19.2 | 19.2 | 19.2 | 19.2 |
| Corn Syrup | 12.9 | 12.9 | 12.9 | 12.9 | 12.9 | 12.9 |
| Glycerin | 1.4 | 1.4 | 1.4 | 0.4 | 0.4 | 0.4 |
| Dextrose | 9.9 | 9.9 | 9.9 | 9.9 | 9.9 | 9.9 |
| Monohydrate | | | | | | |
| Peppermint | 0.9 | 0.9 | 0.09 | 0.9 | 0.9 | 0.9 |
| Flavor | | | | | | |

Illustrative Examples 19-23 in Table 3 demonstrate the use of gum base with polyolefin in low-moisture sugar formulations having less than 2% theoretical moisture:

TABLE 3

| | Illustrative Examples | | | | |
|---|---|---|---|---|---|
| | 19 | 20 | 21 | 22 | 23 |
| Sugar | 58.8 | 58.8 | 58.8 | 53.7 | 53.9 |
| Gum Base | 19.2 | 19.2 | 19.2 | 19.2 | .2 |
| Corn Syrup^{a} | 6.0 | 6.0 | 6.0 | 6.0 | 6.0 |
| Dextrose | 10.0 | 10.0 | 10.0 | 10.0 | 10.0 |
| Monohydrate | | | | | |
| Lactose | 0.0 | 0.0 | 0.0 | 5.0 | 5.0 |
| Glycerin^{b} | 5.0 | 5.0 | 5.0 | 5.0 | 5.0 |
| Flavor | 0.9 | 0.9 | 0.9 | 0.9 | 0.9 |
| Lecithin | 0.1 | 0.1 | 0.1 | 0.2 | — |

^{a}Corn syrup is evaporated to 85% solids; 15% moisture.
^{b}Glycerin and syrup can be blended and co-evaporated.

Examples 24-28 in Table 4 illustrate the use of gum base with polyolefin in medium-moisture sugar formulations having about 2% to about 5% moisture.

TABLE 4

| | Illustrative Examples | | | | |
|---|---|---|---|---|---|
| | 24 | 25 | 26 | 27 | 28 |
| Sugar | 53.4 | 53.4 | 53.4 | 53.3 | 53.5 |
| Gum Base | 19.2^{c} | 19.2^{d} | 19.2^{e} | 19.2^{e} | 19.2^{e} |
| Corn Syrup^{a} | 15.0 | 15.0 | 15.0 | 15.0 | 15.0 |
| Dextrose | 10.0 | 10.0 | 10.0 | 10.0 | 10.0 |
| Monohydrate | | | | | |
| Glycerin^{b} | 1.4 | 1.4 | 1.4 | 1.4 | 1.4 |
| Flavor | 0.9 | 0.9 | 0.9 | 0.9 | 0.9 |
| Lecithin | 0.1 | 0.1 | 0.1 | 0.2 | — |

^{a}Corn syrup is evaporated to 85% solids; 15% moisture.
^{b}Glycerin and syrup can be blended and co-evaporated.
^{c}Gum base may include Engage ™ polyolefin TPE.
^{d}Gum base may include Vistamaxx ™ polyolefin TPE.
^{e}Gum base may include Engage ™ and Vistamaxx ™ polyolefin TPE's.

Examples 29-33 in Table 5 illustrate use of gum base with a polyolefin TPE in high moisture sugar formulations having more than about 5% moisture.

TABLE 5

| | Illustrative Examples | | | | |
|---|---|---|---|---|---|
| | 29 | 30 | 31 | 32 | 33 |
| Sugar | 51.0 | 50.9 | 50.9 | 49.9 | 50.0 |
| Gum Base | 24.0 | 24.0 | 24.0 | 24.0 | 24.0 |
| Corn Syrup | 24.0 | 24.0 | 24.0 | 24.6 | 24.6 |
| Glycerin | 0.0 | 0.0 | 0.0 | 0.4 | 0.4 |
| Flavor | 1.0 | 1.0 | 1.0 | 1.0 | 1.0 |
| Lecithin | — | 0.1 | 0.1 | 0.1 | — |

Illustrative Examples 34-38 in Table 6 and Illustrative Examples 39-48 in Tables 7 and 8 illustrate use of gum base with a polyolefin TPE in low- and high-moisture gums that are sugar-free. Low-moisture gums have less than about 2% moisture, and high-moisture gums have greater than 2% moisture. Gum bases may include Engage™ and Vistamaxx™polyolefin TPE's.

TABLE 6

| | Illustrative Examples | | | | |
|---|---|---|---|---|---|
| | 34 | 35 | 36 | 37 | 38 |
| Gum Base | 25.55 | 25.7 | 26.0 | 26.5 | 27.5 |
| Sorbitol | 50.85 | 50.7 | 50.5 | 50.0 | 48.0 |
| Mannitol | 12.0 | 12.0 | 12.0 | 12.0 | 13.0 |
| Glycerin | 10.0 | 10.0 | 10.0 | 10.0 | 10.0 |
| Flavor | 1.5 | 1.5 | 1.5 | 1.5 | 1.5 |
| Lecithin | 0.1 | 0.1 | — | — | — |

TABLE 7

| | Illustrative Examples | | | | |
|---|---|---|---|---|---|
| | 39 | 40 | 41 | 42 | 43 |
| Gum Base | 25.55 | 25.7 | 26.0 | 26.5 | 27.5 |
| Sorbitol | 50.95 | 50.8 | 50.5 | 51.9 | 49.8 |
| Sorbitol | 10.0 | 10.0 | 10.0 | 10.0 | 11.0 |
| Liquid* | | | | | |
| Mannitol | 10.0 | 10.0 | 10.0 | 10.0 | 10.0 |
| Glycerin | 2.0 | 2.0 | 2.0 | 0.0 | 0.0 |
| Flavor | 1.5 | 1.5 | 1.5 | 1.5 | 1.5 |
| Lecithin | — | — | — | 0.1 | 0.2 |

*Sorbitol liquid contains 70% sorbitol; 30% water.

TABLE 8

| | Illustrative Examples | | | | |
|---|---|---|---|---|---|
| | 44 | 45 | 46 | 47 | 48 |
| Gum Base | 25.55 | 25.7 | 26.0 | 26.5 | 27.5 |
| Sorbitol | .95 | 50.7 | 50.4 | 52.0 | 51.0 |
| HSH Syrup* | 10.500 | 10.0 | 10.0 | 10.0 | 10.0 |
| Mannitol | 8.0 | 8.0 | 8.0 | 8.0 | 9.0 |
| Glycerin** | 4.0 | 4.0 | 4.0 | 2.0 | 1.0 |
| Flavor | 1.5 | 1.5 | 1.5 | 1.5 | 1.5 |
| Lecithin | — | 0.1 | 0.1 | — | — |

*Lycasin brand hydrogenated starch hydrolyzate syrup.
**Glycerin and HSH Syrup may be blended and co-evaporated.

Table 9 shows sugar chewing gum formulations that can be made with gum base with polyolefin and various types of sugars.

TABLE 9

| | Illustrative Examples | | | | | |
|---|---|---|---|---|---|---|
| | 49 | 50 | 51 | 52 | 53 | 54 |
| Gum Base | 19.3 | 20.2 | 19.3 | 20.2 | 19.3 | 20.2 |
| Sucrose | 49.4 | 48.5 | 44.4 | 43.5 | 34.4 | 43.5 |
| Glycerin | 1.4 | 1.4 | 1.4 | 1.4 | 1.4 | 1.4 |
| Corn Syrup | 14.0 | 14.0 | 14.0 | 14.0 | 14.0 | 14.0 |
| Dextrose | 5.0 | 5.0 | — | — | 10.0 | 5.0 |
| Lactose | 5.0 | 5.0 | 10.0 | 10.0 | — | — |
| Fructose | 5.0 | 5.0 | 10.0 | 10.0 | 10.0 | 5.0 |
| Invert Sugar | — | — | — | — | 10.0 | 10.0 |
| Maltose | — | — | — | — | — | — |
| Corn Syrup | — | — | — | — | — | — |
| Solids | | | | | | |
| Peppermint | 0.9 | 0.9 | 0.9 | 0.9 | 0.9 | 0.9 |
| Flavor | | | | | | |
| | Illustrative Examples | | | | | |
| | 55 | 56 | 57 | 58 | 59 | 60 |
| Gum Base | 19.3 | 20.2 | 19.3 | 20.2 | 19.3 | 20.2 |
| Sucrose | 34.4 | 43.5 | 34.4 | 43.5 | 42.4 | 46.5 |
| Glycerin | 1.4 | 1.4 | 1.4 | 1.4 | 1.4 | 1.4 |
| Corn Syrup | 14.0 | 14.0 | 14.0 | 14.0 | 11.0 | 11.0 |
| Dextrose | 10.0 | 5.0 | 10.0 | 5.0 | 10.0 | 5.0 |
| Lactose | — | — | — | — | — | — |
| Fructose | 10.0 | 5.0 | 10.0 | 5.0 | 5.0 | 5.0 |
| Invert Sugar | 10.0 | 10.0 | — | — | 5.0 | 5.0 |
| Maltose | — | — | 10.0 | 10.0 | — | — |
| Corn Syrup | — | — | — | — | 5.0 | 5.0 |
| Solids | | | | | | |
| Peppermint | 0.9 | 0.9 | 0.9 | 0.9 | 0.9 | 0.9 |
| Flavor | | | | | | |

Illustrative
Examples

| | 61 | 62 |
|---|---|---|
| Gum Base | 19.3 | 20.2 |
| Sucrose | 42.4 | 36.5 |
| Glycerin | 6.4 | 6.4 |
| Corn Syrup | 11.0 | 11.0 |
| Dextrose | 5.0 | 5.0 |
| Lactose | — | — |
| Fructose | 5.0 | 5.0 |
| Invert Sugar | 5.0 | 5.0 |
| Maltose | — | — |
| Corn Syrup | 5.0* | 10.0* |
| Solids | | |
| Peppermint | 0.9 | 0.9 |
| Flavor | | |

*(e.g., 5-25DE maltodextrin)

Table 10 shows sugar-free chewing gum formulations. These formulations can use a wide variety of other non-sugar alditols.

TABLE 10

| | Illustrative Examples | | | | | |
|---|---|---|---|---|---|---|
| | 63 | 64 | 65 | 66 | 67 | 68 |
| Gum Base | 25.6 | 26.5 | 25.6 | 26.5 | 25.6 | 26.5 |
| Glycerin | 2.0 | 2.0 | 2.0 | 2.0 | 2.0 | 2.0 |
| Sorbitol | 43.9 | 43.0 | 43.9 | 38.0 | 37.9 | 39.0 |
| Mannitol | — | 10.0 | 10.0 | 10.0 | 10.0 | 6.0 |
| Sorbitol | 17.0 | 17.0 | — | — | — | — |
| Liquid | | | | | | |
| Lycasin | — | — | 17.0 | 12.0 | 8.0 | 10.0 |
| Maltitol | 10.0 | — | — | 10.0 | — | — |
| Xylitol | — | — | — | — | 15.0 | 15.0 |
| Lactitol | — | — | — | — | — | — |
| Palatinit | — | — | — | — | — | — |
| Flavor | 1.5 | 1.5 | 1.5 | 1.5 | 1.5 | 1.5 |
| | Illustrative Examples | | | | | |
| | 69 | 70 | 71 | 72 | 73 | 74 |
| Gum Base | 25.6 | 26.5 | 25.6 | 26.5 | 25.6 | 26.5 |
| Glycerin | 8.0 | 8.0 | 8.0 | 2.0 | 1.0 | 0.0 |
| Sorbitol | 41.9 | 36.0 | 31.9 | 40.0 | 26.9 | 21.0 |
| Mannitol | 8.0 | 8.0 | 8.0 | — | — | — |
| Sorbitol | 5.0 | — | — | — | — | — |
| Liquid | | | | | | |
| Lycasin | — | 5.0 | 5.0 | 5.0 | 10.0 | 10.0 |
| Maltitol | 10.0 | 10.0 | 10.0 | — | — | — |
| Xylitol | — | — | — | 15.0 | 10.0 | 20.0 |
| Lactitol | 10.0 | 10.0 | 10.0 | — | — | — |
| Palatinit | — | — | 10.0 | 10.0 | 25.0 | 21.0 |
| Flavor | 1.5 | 1.5 | 1.5 | 1.5 | 1.5 | 1.5 |

The following illustrative examples of the invention are shown in Tables 11 and 12 for natural and synthetic gum bases with wax, Table 13 for chewing gum bases that are wax-free and have some reduced tack properties, Table 14 for wax free bubble gum bases, and Table 15 for wax-free gum bases having non-tack characteristics. These examples describe polyolefin elastomers as a replacement for butyl rubber.

TABLE 11
NATURAL AND SYNTHETIC BASES WITH WAX

| | ILLUSTRATIVE EXAMPLES | | |
|---|---|---|---|
| | 75 | 76 | 77 |
| Polyolefin TPE | 11.7 | 10.0 | 9.0 |
| Styrene Butadiene Rubber | — | — | — |
| Polyisobutylene | — | 10.4 | 5.3 |
| Jelutong | — | — | — |
| Ester Gum | 14.8 | — | — |
| Terpene Resin | 9.9 | 6.8 | 16.7 |
| Low MW Polyvinylacetate | 21.2 | 23.2 | 24.6 |
| High MW Polyvinylacetate | — | — | — |
| Talc | — | — | — |
| Calcium Carbonate | 11.2 | 14.7 | 20.1 |
| Acetylated Monoglyceride | — | — | — |
| Hydrogenated Cotton Seed Oil | — | 10.0 | 3.3 |
| Hydrogenated Soybean Oil | 9.0 | 11.1 | 3.3 |
| Partially Hydrogenated Soybean | 5.7 | 2.3 | — |
| and Palm Oil | | | |
| Partially Hydrogenated | — | 4.3 | 4.2 |
| Cotton seed Oil | | | |
| Lecithin | 2.7 | — | 0.8 |
| Glycerol Monostearate | 4.8 | 4.1 | 4.2 |
| Triacetin | — | — | — |
| Microcrystalline Wax | 6.0 | 3.1 | 8.5 |
| (melting point (MP) approx. 180° F./ | | | |
| 80° C.) | | | |
| Paraffin Wax | 3.0 | — | — |
| (MP approx. 135° F./60° C.) | | | |
| | 100.0 | 100.0 | 100.0 |

TABLE 12
BUBBLE GUM BASES

| | ILLUSTRATIVE EXAMPLES | | | | | |
|---|---|---|---|---|---|---|
| | 78 | 79 | 80 | 81 | 82 | 83 |
| Polyolefin TPE | — | — | 2.5 | 6.8 | 6.8 | 8.8 |
| Styrene Butadiene Rubber | 10.3 | 1.6 | — | — | — | — |
| Polyisobutylene | — | 9.1 | 9.0 | 3.0 | 3.2 | 4.1 |
| Jelutong | — | — | — | 21.1 | 18.2 | 4.0 |
| Ester Gum | 24.7 | 22.5 | 15.0 | 16.7 | 16.6 | — |
| Terpene Resin | — | — | — | — | — | 17.3 |
| Low MW Polyvinylacetate | — | — | — | 16.6 | 16.1 | 25.0 |
| High MW Polyvinylacetate | — | 30.0 | 24.1 | — | — | — |
| Talc | — | — | 25.4 | — | — | 18.1 |
| Calcium Carbonate | 56.8 | 21.7 | — | 13.2 | 19.7 | — |
| Acetylated Monoglyceride | — | — | 4.0 | — | — | — |
| Hydrogenated Cotton Seed | 1.5 | — | — | 2.3 | — | 4.5 |
| Oil | | | | | | |
| Hydrogenated Soybean Oil | — | — | — | — | 3.2 | 2.7 |
| Partially Hydrogenated | — | 2.0 | — | — | — | — |
| Soybean and Palm Oil | | | | | | |
| Partially Hydrogenated | — | — | — | — | 2.0 | — |
| Cottonseed Oil | | | | | | |
| Lecithin | 1.5 | 1.5 | 3.5 | 3.0 | 1.8 | 3.3 |
| Glycerol Monostearate | 1.1 | — | 7.1 | 2.1 | 4.5 | 4.1 |
| Triacetin | — | 4.5 | 3.2 | — | — | — |
| Microcrystalline Wax | — | — | 1.2 | 15.2 | 6.8 | 6.1 |
| (MP approx. 180° F./80° C.) | | | | | | |
| Paraffin Wax | 4.1 | 7.1 | 5.0 | — | 1.1 | 2.0 |
| (MP approx. 135° F./60° C.) | | | | | | |
| | ILLUSTRATIVE EXAMPLES | | | | | |
| | 84 | 85 | 86 | 87 | 88 | 89 |
| Polyolefin TPE | — | 9.1 | 9.3 | 6.1 | 8.1 | — |
| Styrene Butadiene Rubber | — | — | — | — | — | 6.0 |
| Polyisobutylene | 8.0 | 3.5 | 10.5 | 7.1 | 5.5 | 7.5 |
| Jelutong | — | 3.1 | — | — | — | — |
| Ester Gum | 14.7 | 1.5 | — | — | 7.1 | 12.2 |
| Terpene Resin | — | 15.0 | 13.0 | 14.1 | 7.1 | — |
| Low MW Polyvinylacetate | — | 22.8 | 23.0 | 28.1 | 22.2 | — |
| High MW Polyvinylacetate | 34.5 | — | — | — | — | 29.0 |
| Talc | 28.6 | — | — | — | — | 28.9 |
| Calcium Carbonate | — | 23.0 | 14.9 | 18.9 | 25.6 | — |
| Acetylated Monoglyceride | 2.5 | — | — | — | — | 3.7 |
| Hydrogenated Cotton Seed | — | 4.6 | 8.0 | 10.1 | 13.2 | 2.7 |
| Oil | | | | | | |
| Hydrogenated Soybean Oil | — | 2.9 | 5.2 | 5.1 | 5.1 | — |
| Partially Hydrogenated | 0.9 | — | 3.1 | 4.1 | 4.1 | — |
| Soybean and Palm Oil | | | | | | |
| Partially Hydrogenated | — | 2.4 | 1.5 | — | — | 1.3 |
| Cottonseed Oil | | | | | | |
| Lecithin | — | 0.8 | — | 0.7 | 0.5 | — |
| Glycerol Monostearate | 4.4 | 2.8 | 4.5 | 1.5 | 1.5 | 3.1 |
| Triacetin | 4.6 | — | — | — | — | 1.2 |
| Microcrystalline Wax | — | 7.0 | 4.4 | 3.1 | — | 4.4 |
| (MP approx. 180° F./80° C.) | | | | | | |
| Paraffin Wax | 1.8 | 1.5 | 0.5 | 1.1 | — | — |
| (MP approx. 135° F./60° C.) | | | | | | |
| | 100.0 | 100.0 | 100.0 | 100.0 | 100.0 | 100.0 |

Table 13 shows wax-free gum bases for use in chewing gum having reduced tack characteristics in Illustrative Examples 90-119.

TABLE 13

| | ILLUSTRATIVE EXAMPLES | | | | |
|---|---|---|---|---|---|
| | 90 | 91 | 92 | 93 | 94 |
| SYNTHETIC ELASTOMERS: | | | | | |
| Styrene-Butadiene Elastomer | 5.3 | — | 2.1 | 1.8 | — |
| Polyolefin Elastomer | 8.6 | 7.9 | 7.2 | — | 8.1 |
| Polyisobutylene Elastomer | 7.1 | — | 7.4 | 24.8 | 3.6 |
| Polyvinyl Acetate | 10.5 | 27.2 | 15.3 | 10.1 | 27.3 |
| ELASTOMER PLASTICIZERS: | | | | | |
| Glycerol Esters of Rosin | 2.1 | — | 19.0 | 3.7 | — |
| Glycerol Esters of Partially | 4.3 | 18.2 | — | 7.9 | — |
| Hydrogenated Rosin | | | | | |
| Terpene Resins | 10.8 | — | — | 7.1 | 26.8 |
| FILLERS: | | | | | |
| Calcium Carbonate | — | 15.9 | 20.7 | 17.7 | 11.4 |
| Talc | 25.5 | — | — | — | — |
| SOFTENERS: | | | | | |
| Hydrogenated Cottonseed Oil | — | 6.0 | — | 7.0 | — |
| Hydrogenated Soybean Oil | 4.3 | — | 6.1 | — | — |
| Partially Hydrogenated Soybean and | 3.3 | 11.3 | 6.0 | 7.0 | 9.1 |
| Palm Oil | | | | | |
| Partially Hydrogenated Cottonseed Oil | 7.7 | 5.3 | 12.2 | 7.0 | 5.2 |
| Glycerol Monostearate | 8.2 | 7.4 | 4.0 | 3.5 | 4.8 |
| Lecithin | 2.3 | 0.8 | — | 2.4 | 3.7 |

| | ILLUSTRATIVE EXAMPLES | | | | | | |
|---|---|---|---|---|---|---|---|
| | 95 | 96 | 97 | 98 | 99 | 100 | 101 |
| SYNTHETIC ELASTOMERS: | | | | | | | |
| Styrene-Butadiene Elastomer | 5.2 | 2.1 | 5.9 | 3.9 | 2.1 | — | — |
| Polyolefin Elastomer | 4.1 | 7.2 | 6.9 | 5.3 | 6.0 | 8.9 | 3.6 |
| Polyisobutylene Elastomer | 5.9 | 7.3 | 2.0 | 12.7 | 8.5 | 10.0 | 11.1 |
| Polyvinyl Acetate | 25.7 | 15.3 | 24.8 | 14.9 | 15.3 | 21.3 | 21.9 |
| ELASTOMER PLASTICIZERS: | | | | | | | |
| Glycerol Esters of Rosin | 23.5 | 19.1 | 8.6 | — | 10.1 | — | 19.6 |
| Glycerol Esters of Partially | — | — | 8.0 | — | 8.9 | — | 11.2 |
| Hydrogenated Rosin | | | | | | | |
| Terpene Resins | 3.2 | — | 1.9 | 21.4 | — | 9.7 | 3.7 |
| FILLERS: | | | | | | | |
| Calcium Carbonate | 15.1 | 20.7 | 9.9 | 13.7 | 20.9 | 21.5 | 6.4 |
| Talc | — | — | 7.2 | 1.4 | — | — | — |
| SOFTENERS: | | | | | | | |
| Hydrogenated Cottonseed Oil | 3.7 | 6.4 | 7.0 | — | 4.2 | — | 5.0 |
| Hydrogenated Soybean Oil | — | — | 10.1 | 1.7 | 10.0 | 5.0 | 4.2 |
| Partially Hydrogenated Soybean | 5.5 | 8.3 | 4.0 | 10.0 | 10.0 | 3.2 | 10 |
| and Palm Oil | | | | | | | |
| Partially Hydrogenated | 3.0 | 9.6 | — | 7.0 | — | 15.0 | — |
| Cottonseed Oil | | | | | | | |
| Glycerol Monostearate | 5.1 | 4.0 | 3.7 | 5.7 | 4.0 | 5.4 | 3.3 |
| Lecithin | — | — | — | 2.3 | — | — | — |

| | ILLUSTRATIVE EXAMPLES | | | | |
|---|---|---|---|---|---|
| | 102 | 103 | 104 | 105 | 106 |
| SYNTHETIC ELASTOMERS: | | | | | |
| Styrene-Butadiene Elastomer | — | 3.2 | 4.1 | — | — |
| Polyolefin Elastomer | 7.4 | 7.3 | 11.3 | 10.0 | 8.3 |
| Polyisobutylene Elastomer | 1.9 | 7.5 | 7.9 | 1.9 | 3.6 |
| Polyvinyl Acetate | 24.8 | 21.1 | 18.2 | 27.6 | 27.5 |
| ELASTOMER PLASTICIZERS: | | | | | |
| Glycerol Esters of Rosin | — | 15.3 | — | — | — |
| Glycerol Esters of Partially | — | 2.4 | 26.2 | — | — |
| Hydrogenated Rosin | | | | | |
| Terpene Resins | 25.8 | 5.8 | 1.4 | 25.3 | 25.3 |
| FILLERS: | | | | | |
| Calcium Carbonate | 18.6 | — | 13.6 | 11.3 | 11.3 |
| Talc | — | 14.8 | — | — | — |
| SOFTENERS: | | | | | |
| Hydrogenated Cottonseed Oil | 2.0 | 4.4 | 1.2 | — | — |
| Hydrogenated Soybean Oil | 3.0 | 3.0 | — | 2.4 | 4.0 |
| Partially Hydrogenated Soybean and | 3.0 | 4.0 | 7.0 | 3.0 | 4.2 |
| Palm Oil | | | | | |
| Partially Hydrogenated Cottonseed Oil | 4.3 | 4.4 | — | 7.0 | 8.3 |
| Glycerol Monostearate | 4.4 | 2.8 | 5.2 | 4.8 | 4.8 |
| Lecithin | 4.8 | — | 3.9 | 3.7 | 2.7 |

| | ILLUSTRATIVE EXAMPLES | | | | | | | |
|---|---|---|---|---|---|---|---|---|
| | 107 | 108 | 109 | 110 | 111 | 112 | 113 | 114 |
| NATURAL ELASTOMERS: | | | | | | | | |
| Natural Gum | 22.0 | 25.1 | 22.8 | 17.6 | 15.7 | 22.6 | 22.2 | 21.1 |
| SYNTHETIC | | | | | | | | |
| ELASTOMERS: | | | | | | | | |
| Styrene-Butadiene | — | 1.9 | 2.6 | — | 1.9 | — | — | — |
| Elastomer | | | | | | | | |
| Polyolefin Elastomer | 4.8 | 2.1 | 4.1 | 10.2 | 3.7 | 5.8 | 5.7 | 6.1 |
| Polyisobutylene Elastomer | 5.7 | 4.7 | 3.2 | 2.1 | 4.1 | 3.1 | 3.1 | 2.8 |
| Polyvinyl Acetate | 16.4 | 24.8 | 16.3 | 26.9 | 26.2 | 20.4 | 22.0 | 18.0 |
| ELASTOMER | | | | | | | | |
| PLASTICIZERS: | | | | | | | | |
| Glycerol Esters of Rosin | 3.8 | 3.2 | 6.9 | 11.3 | — | — | — | 15.7 |
| Glycerol Esters of Partially | 12.3 | 12.6 | 11.8 | 4.8 | 15.3 | 11.7 | 15.2 | — |
| Hydrogenated Rosin | | | | | | | | |
| Methyl Esters of Rosin | — | 2.1 | 1.7 | — | — | 4.0 | — | — |
| Terpene Resins | — | — | — | — | — | — | — | — |
| FILLERS: | | | | | | | | |
| Calcium Carbonate | — | 4.4 | 9.3 | — | 12.2 | 11.6 | 11.4 | — |
| Talc | 7.1 | — | — | 4.6 | — | — | — | 15.4 |
| SOFTENERS: | | | | | | | | |
| Hydrogenated Cottonseed | 5.8 | — | 10.0 | 5.6 | — | 2.0 | — | 9.1 |
| Oil | | | | | | | | |
| Hydrogenated Soybean Oil | 5.0 | 3.6 | 4.5 | 5.6 | 3.0 | — | 6.2 | — |
| Partially Hydrogenated | 6.0 | 9.0 | 3.7 | 5.0 | 3.1 | 15.0 | 4.9 | 3.0 |
| Soybean and Palm Oil | | | | | | | | |
| Partially Hydrogenated | 5.0 | — | — | — | 9.0 | 1.5 | 5.0 | 3.0 |
| Cottonseed Oil | | | | | | | | |
| Glycerol Monostearate | 6.1 | 3.8 | — | 6.3 | 5.8 | 3.3 | 3.3 | 5.8 |
| Lecithin | — | 2.7 | 3.1 | — | — | — | — | — |

| | ILLUSTRATIVE EXAMPLES | | | | |
|---|---|---|---|---|---|
| | 115 | 116 | 117 | 118 | 119 |
| NATURAL ELASTOMERS: | | | | | |
| Natural Gum | 23.8 | 18.7 | 14.4 | 18.2 | 25.2 |
| SYNTHETIC ELASTOMERS: | | | | | |
| Styrene-Butadiene Elastomer | — | — | — | — | — |
| Polyolefin Elastomer | 3.1 | 6.0 | 9.1 | 6.8 | 2.4 |
| Polyisobutylene Elastomer | 7.7 | 5.5 | 3.6 | 5.4 | 4.9 |
| Polyvinyl Acetate | 20.5 | 14.8 | 18.1 | 15.5 | 19.9 |
| ELASTOMER PLASTICIZERS: | | | | | |
| Glycerol Esters of Rosin | — | — | 11.9 | — | 15.6 |
| Glycerol Esters of Partially | 10.4 | 15.5 | 13.0 | 12.7 | — |
| Hydrogenated Rosin | | | | | |
| Methyl Esters of Rosin | 2.0 | — | — | 2.6 | — |
| Terpene Resins | 5.1 | — | — | — | 2.1 |
| FILLERS: | | | | | |
| Calcium Carbonate | — | 18.83 | 14.1 | 15.7 | — |
| Talc | 5.3 | — | — | — | 7.1 |
| SOFTENERS: | | | | | |
| Hydrogenated Cottonseed Oil | — | 6.5 | 7.0 | — | 2.0 |
| Hydrogenated Soybean Oil | 7.9 | — | 3.0 | 5.0 | 10.0 |
| Partially Hydrogenated Soybean and | 3.0 | 3.0 | 2.0 | 5.0 | 2.4 |
| Palm Oil | | | | | |
| Partially Hydrogenated Cottonseed Oil | 4.9 | 3.5 | 3.8 | 6.0 | 4.0 |
| Glycerol Monostearate | 6.3 | 7.7 | — | 7.1 | 4.4 |
| Lecithin | — | — | — | — | — |

Table 14 shows wax-free gum bases for use in bubble gum in illustrative examples 120-128.

TABLE 14

| | ILLUSTRATIVE EXAMPLES | | | |
|---|---|---|---|---|
| | 120 | 121 | 122 | 123 |
| SYNTHETIC ELASTOMERS: | | | | |
| Polyisobutylene Elastomer | 10.1 | 6.7 | 6.6 | — |
| Polyolefin Elastomer | 7.0 | 5.0 | 5.0 | 5.4 |
| Polyvinyl Acetate | 24.9 | 29.4 | 31.5 | 34.8 |
| ELASTOMER PLASTICIZERS: | | | | |
| Glycerol Esters of Rosin | 6.8 | 10.7 | 19.8 | 16.3 |
| Glycerol Esters of Partially | — | — | — | — |
| Hydrogenated Rosin | | | | |
| FILLERS: | | | | |
| Calcium Carbonate | — | — | — | 30.2 |
| Talc | 34.7 | 34.1 | 21.9 | — |
| SOFTENERS: | | | | |
| Glycerol Triacetate | 4.6 | 4.4 | 5.0 | 5.3 |
| Glycerol Monostearate | 6.9 | 8.7 | 7.9 | 5.9 |
| Acetylated Monoglyceride | 5.0 | 2.0 | 2.3 | 2.1 |

| | ILLUSTRATIVE EXAMPLES | | | | |
|---|---|---|---|---|---|
| | 124 | 125 | 126 | 127 | 128 |
| SYNTHETIC | | | | | |
| ELASTOMERS: | | | | | |
| Polyisobutylene Elastomer | 3.9 | 6.0 | 2.0 | 6.0 | 2.0 |
| Polyolefin Elastomer | 4.0 | 7.0 | 5.9 | 5.6 | 9.8 |
| Polyvinyl Acetate | 34.2 | 37.1 | 34.2 | 37.8 | 35.6 |
| ELASTOMER | | | | | |
| PLASTICIZERS: | | | | | |
| Glycerol Esters of Rosin | 14.8 | — | — | — | — |
| Glycerol Esters of Partially | — | 19.8 | 14.8 | 19.8 | 19.8 |
| Hydrogenated Rosin | | | | | |
| FILLERS: | | | | | |
| Calcium Carbonate | 29.8 | 16.5 | 29.8 | — | — |
| Talc | — | — | — | 17.0 | 19.7 |
| SOFTENERS: | | | | | |
| Glycerol Triacetate | 6.3 | 6.6 | 5.3 | 5.6 | 4.8 |
| Glycerol Monostearate | 4.0 | 7.0 | 5.0 | 3.2 | 2.3 |
| Acetylated Monoglyceride | 3.0 | — | 3.0 | 5.0 | 6.0 |

Table 15 shows wax-free gum bases for use in chewing gum having non-tack characteristics in illustrative examples 129-140.

TABLE 15

| | ILLUSTRATIVE EXAMPLES | | | | | |
|---|---|---|---|---|---|---|
| | 129 | 133 | 131 | 132 | 133 | 134 |
| SYNTHETIC | | | | | | |
| ELASTOMERS: | | | | | | |
| Butyl (isoprene- | 8.0 | 5.0 | 6.0 | 5.0 | 7.0 | 6.0 |
| isobutylene) Elastomer | | | | | | |
| Polyolefin Elastomer | 8.0 | 4.9 | 3.9 | 5.0 | 3.0 | 7.3 |
| Polyisobutylene | 10.0 | 15.5 | 15.5 | 15.9 | 15.9 | 21.2 |
| Elastomer | | | | | | |
| Polyvinyl Acetate | 14.0 | 22.0 | 22.0 | 21.7 | 21.6 | 29.1 |
| FILLERS: | | | | | | |
| Calcium Carbonate | 5.0 | 12.9 | 12.9 | 13.3 | — | 17.7 |
| Talc | 10.0 | — | — | — | 13.1 | — |
| SOFTENERS: | | | | | | |
| Hydrogenated Soybean | 11.0 | 14.0 | 9.0 | 13.3 | 13.5 | 6.1 |
| Oil | | | | | | |
| Hydrogenated | 11.0 | 13.0 | 13.0 | 13.3 | 13.5 | 6.1 |
| Cottonseed Oil | | | | | | |
| Partially Hydrogenated | 3.0 | 10.0 | 10.0 | — | 5.0 | 5.2 |
| Soybean and Palm Oil | | | | | | |
| Partially Hydrogenated | 13.0 | — | 5.0 | 9.8 | 4.8 | — |
| Cottonseed Oil | | | | | | |
| Glycerol Monostearate | 2.0 | 2.7 | 1.7 | 2.7 | 2.6 | 1.3 |
| Lecithin | — | — | 1.0 | — | — | — |

Gum bases shown in Table 16 and 17 were prepared in a conventional manner using Engage™ and Vistamaxx™ polyolefin TPE's as indicated.

TABLE 16

| | EXAMPLE | | | | |
|---|---|---|---|---|---|
| | 135 | 136 | 137 | 138 | 139 |
| Vistamaxx 1100 ™ | 10.48 | — | — | — | 8.84 |
| Vistamaxx 6100 ™ | — | 8.84 | — | — | — |
| Vistamax 1120 ™ | — | — | 8.84 | — | — |
| Vistamax 6200 ™ | — | — | — | 8.84 | — |
| Polyisobutylene | — | 1.64 | 1.64 | 1.64 | 1.64 |
| Elastomer | | | | | |
| Terpene Resin | 22.69 | 22.69 | 22.69 | 22.69 | 22.69 |
| Calcium Carbonate | 21.02 | 21.02 | 21.02 | 21.02 | 21.02 |
| Polyvinyl Acetate | 24.40 | 24.40 | 24.40 | 24.40 | 24.40 |
| Hydrogenated Palm Oil | 13.81 | 13.81 | 13.81 | 13.81 | 13.81 |
| Mono- and Di- | 4.25 | 4.25 | 4.25 | 4.25 | 4.25 |
| Glycerides | | | | | |
| Lecithin | 3.29 | 3.29 | 3.29 | 3.29 | 3.29 |
| BHT | 0.06 | 0.06 | 0.06 | 0.06 | 0.06 |

TABLE 17

EXAMPLE

| | 140 | 141 |
|---|---|---|
| Engage 8130 ™ | 9.98 | 10.78 |
| Calcium Carbonate | 10.97 | 3.77 |
| Terpene Resin | 29.42 | 31.81 |
| Polyvinyl Acetate | 21.95 | 23.72 |
| Mono- and Di- | 5.19 | 5.61 |
| Glycerides | | |
| Hydrogenated Palm Oil | 11.97 | 12.94 |
| Hydrogenated | 10.47 | 11.32 |
| Vegetable Oil | | |
| BHT | 0.05 | 0.05 |

Chewing gum compositions were produced using gum bases described in Tables 16 and 17 and are shown in Tables 18 and 19.

TABLE 18

EXAMPLE

| | 142 | 143 |
|---|---|---|
| Gum base of Ex. 137 | 30.00 | — |
| Gum base of Ex. 138 | — | 30.00 |
| Sorbitol | 52.57 | 52.57 |
| Xylitol | 1.00 | 1.00 |
| Talc | 6.00 | 6.00 |
| Glycerin | 5.00 | 5.00 |
| Melon Flavor | 2.40 | 2.40 |
| Citric Acid | 2.00 | 2.00 |
| Encapsulated High | 0.83 | 0.83 |
| Intensity Sweeteners | | |
| Cooling Agent | 0.20 | 0.20 |

TABLE 19

EXAMPLE

| | 144 | 145 |
|---|---|---|
| Gum base of Ex. 140 | 20.00 | — |
| Gum base of Ex. 141 | — | 20.00 |
| Sugar | 60.30 | 60.15 |
| Corn Syrup | 17.00 | 17.00 |
| Peppermint Flavor | 1.50 | 1.65 |
| Lecithin | 0.20 | 0.20 |
| Glycerin | 1.00 | 1.00 |

The chewing gums of Tables 18 and 19 were prepared in a conventional manner and evaluated in an informal sensory test. The gums were found to be comparable to commercial chewing gums of the prior art.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

What is claimed is:

1. A gum base comprising a polyolefin thermoplastic elastomer and a softener.

2. A gum base of claim 1 wherein the polyolefin thermoplastic elastomer is a polymer containing C₂ to C₄ monomer units.

3. A gum base of claim 1 wherein the polyolefin thermoplastic elastomer is an ethylene polymer containing alpha-olefin co-monomer units.

4. A gum base of claim 1 wherein the polyolefin thermoplastic elastomer contains polymeric crystallinity.

5. A gum base of claim 3 wherein the polyolefin thermoplastic elastomer contains propylene, butene, hexene, octene, or combinations thereof, as a co-monomer.

6. A gum base of claim 5 wherein the polyolefin thermoplastic elastomer contains propylene or octene as a co-monomer.

7. A gum base of claim 1 wherein the polyolefin thermoplastic elastomer is formed using a metallocene-based catalyst system.

8. A gum base of claim 1 wherein the gum base further comprises at least one of a filler, polyvinyl acetate and an elastomer plasticizer.

9. A gum base of claim 1 wherein the polyolefin thermoplastic elastomer constitutes from about 1% to about 40% by weight of the gum base.

10. A gum base of claim 9 wherein the polyolefin thermoplastic elastomer constitutes from about 5% to about 20% by weight of the gum base.

11. A gum base of claim 1 wherein the gum base comprises a blend of polyolefin thermoplastic elastomer and at least one other elastomer.

12. A chewing gum comprising:
a) an insoluble gum base comprising polyolefin thermoplastic elastomer containing polymeric crystallinity;
b) a water soluble bulk portion; and
c) a flavor.

13. A chewing gum of claim 11 wherein the polyolefin thermoplastic elastomer constitutes from about 5% to about 30% by weight of the gum base.

14. A chewing gum of claim 13 wherein the polyolefin thermoplastic elastomer constitutes from about 5% to about 20% by weight of the gum base.

15. A chewing gum of claim 12 wherein the gum base further comprises at least one softener chosen from the group consisting of tallow, hydrogenated tallow, hydrogenated vegetable oils, partially hydrogenated vegetable oils, cocoa butter, glycerol monostearate, glycerol triacetate, lecithin, and combinations thereof.

16. A chewing gum of claim 15 wherein the softener comprises lecithin.

17. A chewing gum of claim 12 wherein the chewing gum base further comprises an emulsifier.

18. A chewing gum of claim 12 wherein the gum base further comprises an elastomer plasticizer selected from the group consisting of terpene resins, estergums, and rosin esters and combinations thereof.

19. A method for preparing a chewing gum, comprising mixing an insoluble gum base, a water-soluble bulk portion, and a flavor, wherein the insoluble gum base comprises polyolefin thermoplastic elastomer formed using a metallocene-based catalyst system.

20. A method of claim 19 wherein the polyolefin thermoplastic elastomer is a non-tacky propylene-ethylene or ethylene-octene copolymer.
